(19) United States
(12) Patent Application Publication
(10) Pub. No.: US 2026/0277078 A1
(43) Pub. Date: Sep. 17, 2026

(54) CONNECTION UNIT, ACCESSORY, AND ELECTRONIC DEVICE

(71) Applicant: NIKON CORPORATION, Tokyo (JP)

(72) Inventors: Koji OZAKI, Yokohama-shi (JP); Yasuharu SUGITA, Yokohama-shi (JP); Tomonori MIZOGUCHI, Tokyo (JP); Yoshihiro MATSUMOTO, Kawasaki-shi (JP); Kazuya NISHIO, Kawasaki-shi (JP)

(73) Assignee: NIKON CORPORATION, Tokyo (JP)

(21) Appl. No.: 19/471,571

(22) PCT Filed: Mar. 8, 2024
(86) PCT No.: PCT/JP2024/009101

§ 371 Date: Oct. 1, 2025

(30) Foreign Application Priority Data
Apr. 6, 2023 (JP) 2023-062207

(51) Int. Cl. G03B 13/02; G03B 15/05; G03B 17/56

(52) U.S. Cl. CPC G03B 13/02; G03B 15/05; G03B 17/56

(57) ABSTRACT

To prevent a contact from short-circuiting and breaking due to foreign matters, a connection unit 301A provided in an accessory to be attached to an imaging device includes a connection portion 39A electrically connected to the imaging device, and a plurality of contacts PA1 to PA26 provided in the connection portion and arranged in a row, wherein among the plurality of contacts, a first contact PA15 to which power is supplied from the imaging device is arranged next to an open drain contact or a contact with a reverse current prevention function.

### CROSS-REFERENCE TO RELATED APPLICATION

This application is a national stage application of the prior International Patent Application No. PCT/JP 2024/009101, filed on Mar. 8, 2024, which is based upon and claims the benefit of priority of the prior Japanese Patent Application No. 2023-062207, filed on Apr. 6, 2023, the entire contents of which are incorporated herein by reference.

### FIELD

The present disclosure relates to a connection unit, an accessory, and an electronic device.

### BACKGROUND

Conventionally, an accessory shoe to which a camera accessory such as a flash device is detachably attached is known (for example, see Patent Literature 1). In the device described in Patent Literature 1, an appropriate arrangement of the electrical contacts for data communication is not sufficiently considered.

### CITATION LIST

### Patent Literature

PTL 1: Japanese Patent Application Laid-Open No. 2008-180914

### SUMMARY

According to a first aspect, a connection unit is a connection unit provided in an accessory to be attached to an imaging device, and includes: a connection portion electrically connected to the imaging device; and a plurality of contacts provided in the connection portion and arranged in a row, wherein among the plurality of contacts, a first contact to which power is supplied from the imaging device is arranged next to an open drain contact or a contact with a reverse current prevention function.

According to a second aspect, an accessory is an accessory including: the above connection unit; and a functional unit that is electrically connected to the connection unit and has a function of the accessory.

According to a third aspect, an electronic device is an electronic device having a connection portion to which an accessory is attached and which is electrically connected to the accessory, wherein the connection portion includes a plurality of contacts arranged in a row, and among the plurality of contacts, a contact used for power supply from the electronic device to the accessory is arranged next to an open drain contact or a contact with a reverse current prevention function.

According to a fourth aspect, an electronic device is an electronic device having a connection portion to which an accessory is attached and which is electrically connected to the accessory, wherein the connection portion includes a flexible printed circuit board and a plurality of contacts arranged in a row, and among the plurality of contacts, a plurality of video signal contacts for transmitting video data signals to a display accessory attached to the electronic device are collectively provided at one end side of the row.

According to a fifth aspect, an electronic device is an electronic device to which a first accessory is attached, the first accessory being attached via a second accessory, and includes: a plurality of first contacts and a plurality of second contacts, wherein the plurality of first contacts and the first accessory are electrically connected to each other when the first accessory is attached, and when the first accessory is attached via the second accessory, the second accessory and the electronic device are electrically connected to each other using one or some of the plurality of first contacts and a predetermined contact of the plurality of second contacts.

The configuration of the embodiments described later may be appropriately modified, and at least some of the components may be replaced with other components. Further, the constituent elements whose arrangement is not particularly limited are not limited to the arrangement disclosed in the embodiment, and can be arranged at positions where their functions can be achieved.

### BRIEF DESCRIPTION OF THE DRAWINGS

FIG. 1 is a perspective view (part 1) illustrating an interchangeable lens camera as an electronic device according to an embodiment.

FIG. 2 is a perspective view (part 2) illustrating the interchangeable lens camera as the electronic device according to the embodiment.

FIG. 3 is a view illustrating a case where the accessory is a flash device.

FIG. 4 is a view illustrating a state in which an intermediate adapter is mounted on a camera body and then the flash device is mounted on the intermediate adapter.

FIG. 5 is a view illustrating a state in which the flash device is mounted on the camera body via the intermediate adapter.

FIG. 6A is a view of a shoe seat as viewed from the +Y direction, FIG. 6B is a view of a plug provided in an EVF unit as viewed from below (−Y side), and FIG. 6C is a view of a plug provided in the flash device as viewed from below (−Y side).

FIG. 7A is a view illustrating a state in which the intermediate adapter is viewed from below (−Y side), FIG. 7B is a view illustrating a state in which the intermediate adapter and the plug are viewed from the +X direction, and FIG. 7C is a view illustrating a state in which the intermediate adapter is viewed from above (+Y side).

FIG. 8 is a block diagram schematically illustrating configurations of the camera body and an accessory having a plug similar to that of the EVF unit.

FIG. 9 is a table presenting contact names and functions of 26 electrical contacts provided on the shoe seat.

FIG. 10 is a block diagram schematically illustrating configurations of the camera body and an accessory having a plug similar to that of the flash device.

FIG. 11 is a block diagram schematically illustrating a configuration in which the intermediate adapter is interposed between the camera body and an accessory.

FIG. 12 illustrates an example of a flexible printed circuit board on which wiring lines to be connected to electrical contacts provided on the shoe seat of the camera body (electronic viewfinder-less camera) are provided.

FIG. 13 illustrates an example of a flexible printed circuit board on which wiring lines to be connected to electrical contacts provided on the shoe seat of the camera body (camera with an electronic viewfinder) are provided.

### DESCRIPTION OF EMBODIMENTS

Hereinafter, an embodiment of an electronic device will be described in detail with reference to the drawings. The shapes and the scales such as the lengths, thicknesses, and other dimensions of the components illustrated in the embodiments are not necessarily identical to those of the actual product, and some elements may have been omitted from the drawings for clarity.

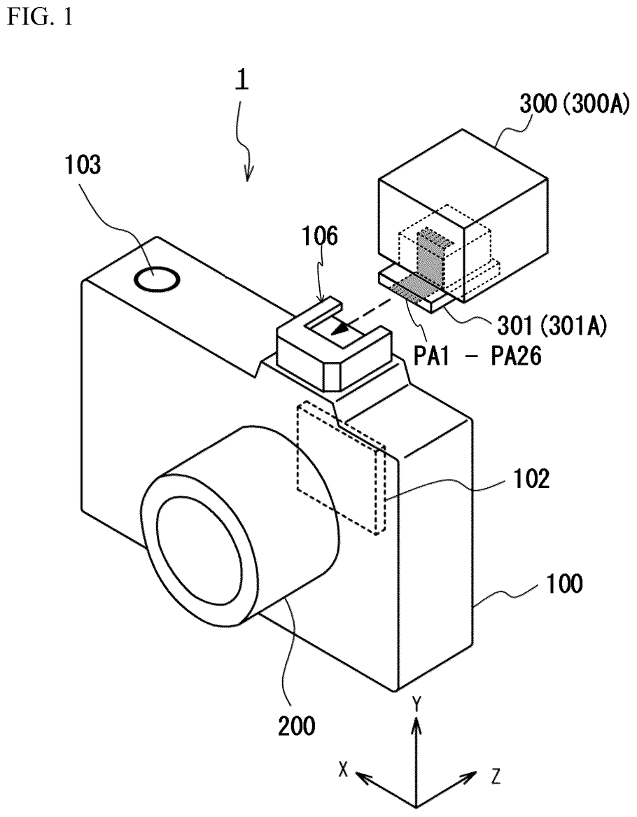

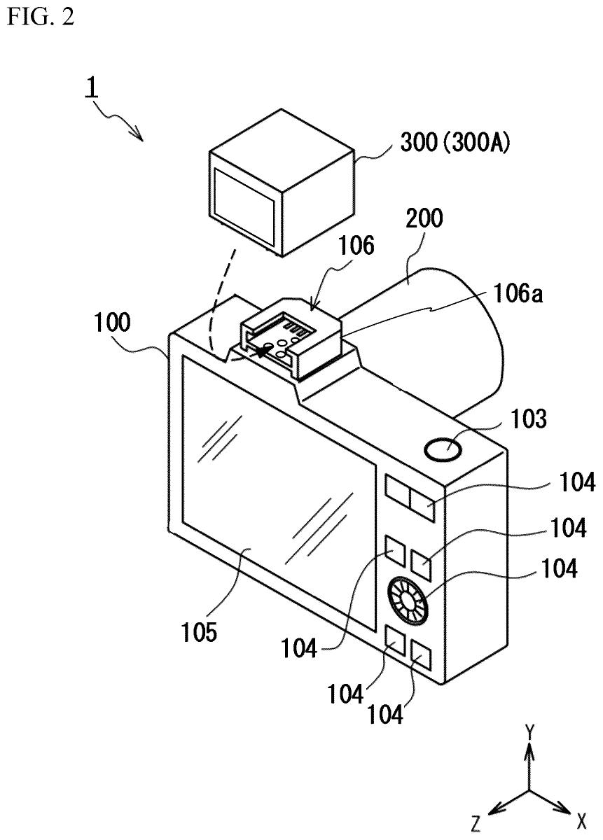

FIG. 1 and FIG. 2 are perspective views illustrating an interchangeable lens camera 1 as an electronic device according to an embodiment. In FIG. 1 and FIG. 2, the optical axis direction of an interchangeable lens 200, which will be described later, is defined as the Z-axis direction, the left-right direction of a camera body 100 is defined as the X-axis direction, and the up-down direction of the camera body 100 is defined as the Y-axis direction.

The camera 1 includes the camera body 100 and the interchangeable lens 200. The user of the camera 1 can select any interchangeable lens 200, and attach it to the camera body 100 to use it. The user of the camera 1 can select any accessory 300 and attach it to the camera body 100 to use it. The camera 1 may not be necessarily an interchangeable lens camera.

The interchangeable lens 200 is detachably attached to the front surface (the −Z-side surface) of the camera body 100. In addition, an image sensor 102 such as a CMOS (Complementary Metal-Oxide-Semiconductor) or a CCD (Charge Coupled Device) is provided in the camera body 100. In addition, a release switch 103 is provided on the upper surface (+Y-side surface) of the camera body 100. Further, as illustrated in FIG. 2, various buttons 104 are provided on the rear surface (+Z-side surface) of the camera body 100. The user can input instructions for photographing, instructions for setting photographing conditions, and the like to the camera body 100 using the release switch 103, the buttons 104, and the like.

As illustrated in FIG. 2, a rear monitor 105 is provided on the rear surface (+Z-side surface) of the camera body 100. The rear monitor 105 is a display device using, for example, a liquid crystal display or the like. The rear monitor 105 displays, for example, a live view of a subject image, a menu for photographing settings, and the like.

An accessory shoe (hereinafter, shoe seat 106) for mounting an accessory 300 is provided on the upper surface (+Y-side surface) of the camera body 100. The shoe seat 106 functions as a connection portion that connects between the accessory 300 and the camera body 100, and the shoe seat 106 is provided with a maintaining portion 106a for maintaining the state in which the accessory 300 is mounted. The maintaining portion 106a holds a plug 301 provided in the accessory 300 so that the accessory 300 does not come off from the camera body 100 even when an external force is applied to the accessory 300.

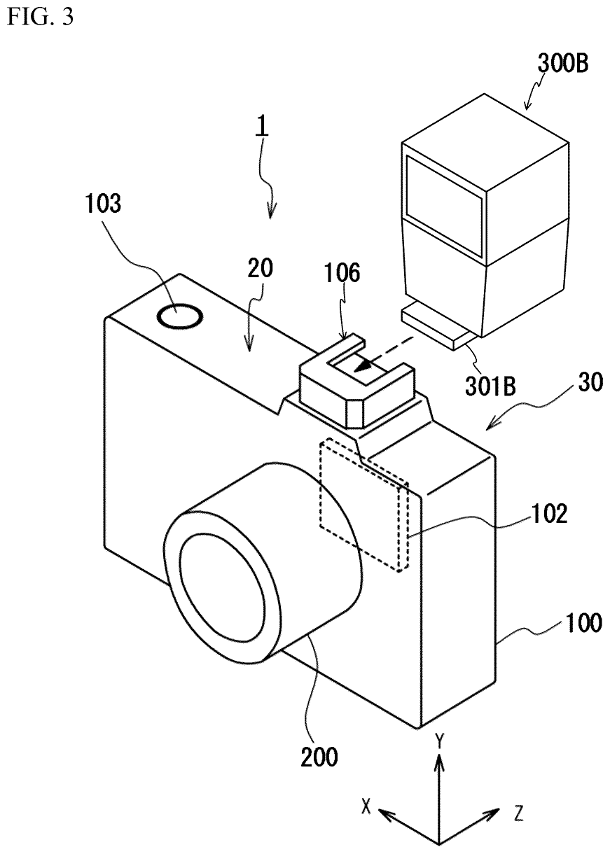

Here, examples of the accessory 300 include an EVF (Electronic ViewFinder) unit, a flash device (flash), an LED light, a tally lamp, a microphone, a GNSS (Global Navigation Satellite System) receiver, an auxiliary imaging device, and a device obtained by combining these. FIG. 1 and FIG. 2 illustrate a case where the accessory 300 is an EVF unit 300A, and FIG. 3 illustrates a case where the accessory 300 is a flash device 300B. The EVF unit 300A in FIG. 1 includes a plug 301A, and the flash device 300B in FIG. 3 includes a plug 301B.

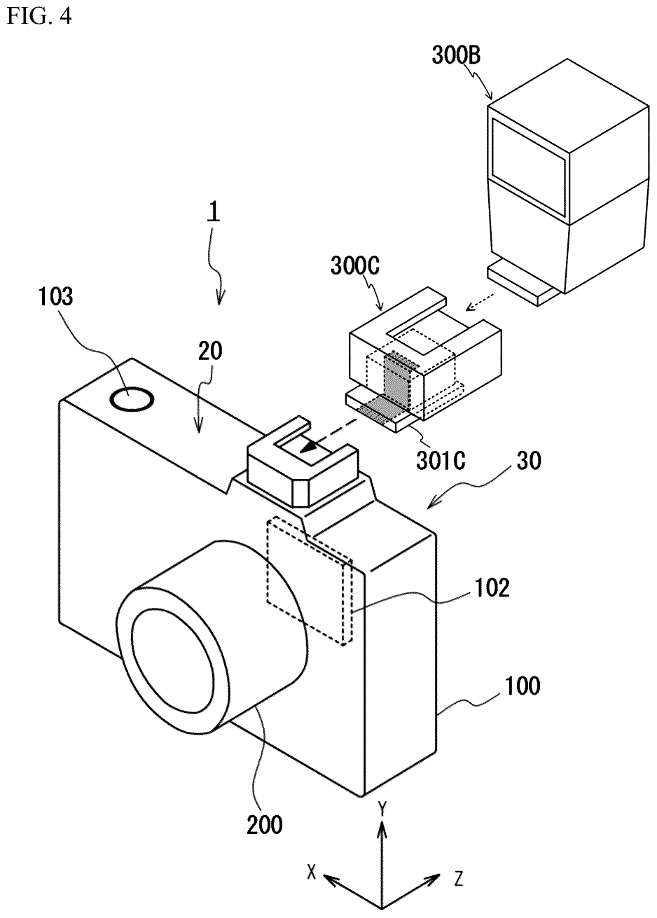

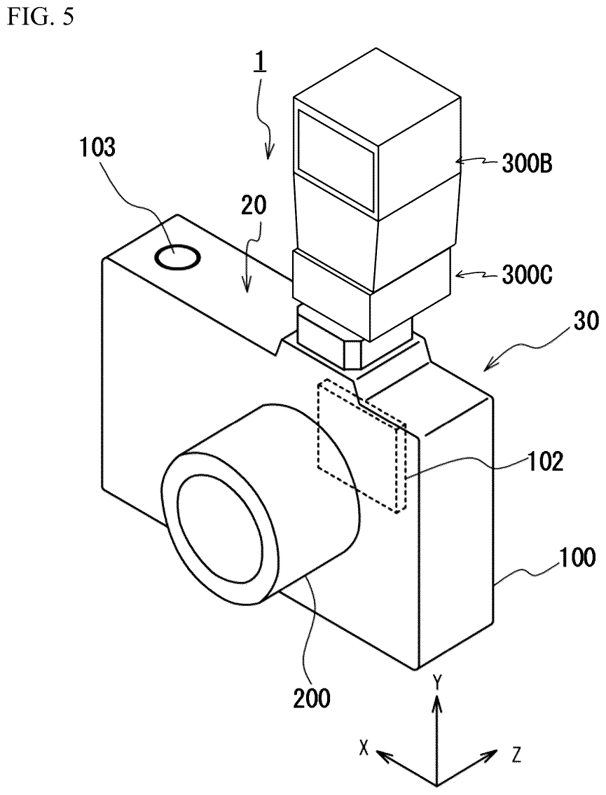

The accessory 300 also includes an intermediate adapter 300C that is interposed between the flash device 300B, the EVF unit 300A, or the like and the camera body 100 when the flash device 300B, the EVF unit 300A, or the like is mounted on the camera body 100 (see FIG. 4 and FIG. 5). The intermediate adapter 300C has built-in functions such as a transceiver of a wireless remote controller and a Genlock, and includes a BNC terminal, a USB terminal, and the like.

FIG. 4 illustrates a state in which the intermediate adapter 300C (second accessory) is mounted on the camera body 100, and then the flash device 300B (first accessory) is mounted on the intermediate adapter 300C. The intermediate adapter 300C includes a plug 301C. FIG. 5 illustrates a state in which the flash device 300B is mounted on the camera body 100 via the intermediate adapter 300C.

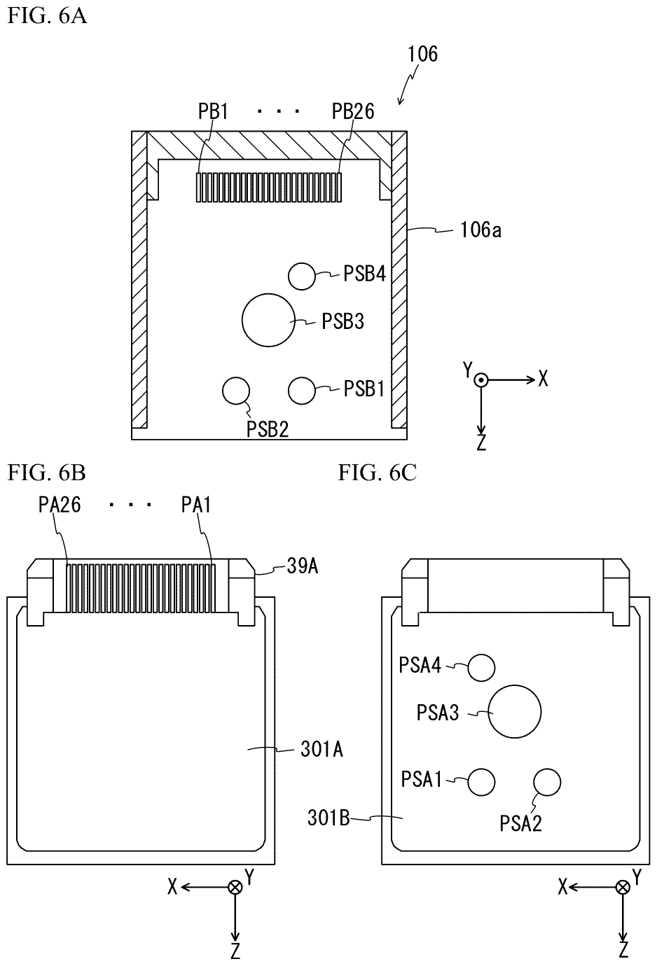

FIG. 6A is a view of the shoe seat 106 as viewed from the +Y direction. In FIG. 6A, the maintaining portion 106a of the shoe seat 106 is illustrated in cross section. As illustrated in FIGS. 6A, 22 or more (26 in FIG. 6A) electrical contacts (second contacts) PB1, PB2, . . . , PB26 are provided in a row along the X-axis direction in the vicinity of the −Z-side end of the upper surface (+Y-side surface) of the shoe seat 106. Four electrical contacts (first contacts) PSB1 to PSB4 are provided in the center portion of the upper surface (+Y-side surface) of the shoe seat 106.

FIG. 6B is a view of the plug 301A of the EVF unit 300A as viewed from below (−Y Side).

As illustrated in FIG. 6B, a connection portion 39A to be connected to a shoe seat 106 is provided at the −Z-side end of the lower surface (the −Y-side surface) of the plug 301A, and 26 electrical contacts PA1 to PA26 are arranged in a row in the X-axis direction on the connection portion 39A. When the EVF unit 300A is attached to the camera body 100, the 26 electrical contacts PA1 to PA26 provided on the lower surface of the plug 301A are physically in contact with the 26 electrical contacts PB1 to PB26 provided on the upper surface of the shoe seat 106, respectively. This electrically connects the 26 electrical contacts PA1 to PA26 and the 26 electrical contacts PB1 to PB26, respectively. Here, each of the electrical contacts PA1 to PA26 has a crank-shaped shape bent at two points in the plug 301A as illustrated in gray in FIG. 1. The shape of each of the electrical contacts PA1 to PA26 is a shape for avoiding mechanical interference with the maintaining portion 106a of the shoe seat 106.

On the other hand, the plug 301A of the EVF unit 300A has no electrical contacts corresponding to the four electrical contacts PSB1 to PSB4 provided on the shoe seat 106. Therefore, even when the EVF unit 300A is mounted on the camera body 100, the four electrical contacts PSB1 to PSB4 are not electrically connected to the EVF unit 300A. That is, the EVF unit 300A does not perform input and output of electric signals with the camera body 100 via the four electric contacts PSB1 to PSB4.

FIG. 6C is a view of the plug 301B provided in the flash device 300B as viewed from below (−Y side).

As illustrated in FIG. 6C, four electrical contacts PSA1 to PSA4 are provided in the center portion of the lower surface (−Y-side surface) of the plug 301B.

When the flash device 300B is mounted on the camera body 100, the four electrical contacts PSA1 to PSA4 provided on the lower surface of the plug 301A are physically in contact with the four electrical contacts PSB1 to PSB4 (FIG. 6A) provided on the upper surface of the shoe seat 106, respectively. This electrically connects the four electrical contacts PSA1 to PSA4 and the four electrical contacts PSB1 to PSB4, respectively.

On the other hand, the plug 301B of the flash device 300B has no electrical contacts corresponding to the 26 electrical contacts PB1 to PB26 provided on the shoe set 106. Therefore, even when the flash device 300B is mounted on the camera body 100, the 26 electrical contacts PB1 to PB26 are not electrically connected to the flash device 300B. That is, the flash device 300B does not perform input and output of electric signals with the camera body 100 via the 26 electric contacts PB1 to PB26.

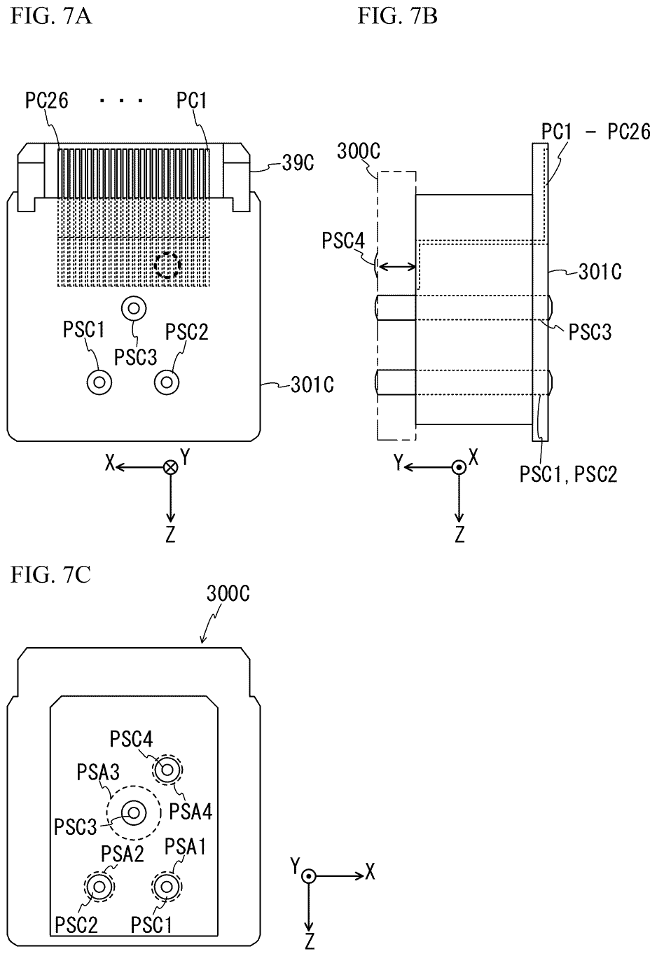

FIG. 7A illustrates the plug 301C of the intermediate adapter 300C as viewed from below (−Y side). FIG. 7B illustrates the intermediate adapter 300C and the plug 301C as viewed from the +X direction, where the intermediate adapter 300C is indicated by a two dot chain line and the plug 301C is indicated by a solid line. FIG. 7C illustrates the intermediate adapter 300C as viewed from above (+Y side).

A connection portion 39C to be connected to the shoe seat 106 is provided at the −Z-side end of the lower surface (−Y-side surface) of the plug 301C, and 26 electrical contacts PC1 to PC26 are arranged in a row in the X-axis direction in the connection portion 39C. When the intermediate adapter 300C is attached to the camera body 100, the 26 electrical contacts PC1 to PC26 provided on the lower surface of the intermediate adapter 300C are physically in contact with the 26 electrical contacts PB1 to PB26 provided on the upper surface of the shoe seat 106, respectively. This electrically contacts the 26 electrical contacts PC1 to PC26 and the 26 electrical contacts PB1 to PB26, respectively.

In addition, three electrical contacts PSC1 to PSC3 are provided in the vicinity of the center portion of the lower surface of the plug 301C. As can be seen from FIG. 7A to 7C, these three electrical contacts PSC1 to PSC3 penetrate through the plug 301C and the intermediate adapter 300C in the Y-axis direction and are exposed on the upper surface of the intermediate adapter 300C. When the intermediate adapter 300C is attached to the camera body 100, the three electrical contacts PSC1 to PSC3 on the lower surface of the intermediate adapter 300C are physically in contact with the three electrical contacts PSB1 to PSB3 (see FIG. 6A) provided on the upper surface of the shoe seat 106, respectively. This electrically connects the three electrical contacts PSC1 to PSC3 and the three electrical contacts PSB1 to PSB3, respectively.

Here, each of the electrical contacts PC1 to PC26 has a crank-shaped shape bent at two points as indicated by broken lines in FIG. 7B, similarly to the electrical contacts PA1 to PA26. The shape of each of the electrical contacts PC1 to PC26 is a shape for avoiding mechanical interference with the maintaining portion 106a of the shoe seat 106. Since the electrical contacts PC1 to PC26 have such a shape and some of the electrical contacts PC1 to PC26 are located at the position indicated by the broken line circle in FIG. 7A, the electrical contact corresponding to the electrical contact PSB4 provided on the shoe seat 106 cannot be provided in a state where it penetrates through the intermediate adapter 300C and the plug 301C in the Y-axis direction, unlike the electrical contacts PSC1 to PSC3. Therefore, even when the intermediate adapter 300C is attached to the camera body 100, the electrical contact PSB4 in FIG. 6A is not electrically connected to the intermediate adapter 300C (plug 301C). That is, the intermediate adapter 300C does not perform input and output of electric signals with the camera body 100 via the electrical contact PSB4.

On the other hand, on the upper surface (+Y-side surface) of the intermediate adapter 300C, in addition to the three electrical contacts PSC1 to PSC3, an electrical contact PSC4 is provided as illustrated in FIG. 7C. That is, the intermediate adapter 300C has electrical contacts that penetrate in the Y-axis direction and an electrical contact that does not penetrate. The electrical contact PSC4 does not penetrate through the intermediate adapter 300C in the Y-axis direction, and is electrically connected to one of the 26 electrical contacts PC1 to PC26 in FIG. 7A (the electrical contact PC13 in the present embodiment) through the flexible printed circuit board (see the double-headed arrow in FIG. 7B).

As a result, when the flash device 300B is mounted on the upper surface of the intermediate adapter 300C, the four electrical contacts PSA1 to PSA4 provided on the lower surface of the flash device 300B (see FIG. 6C) are physically in contact with the four electrical contacts PSC1 to PSC4 provided on the upper surface of the intermediate adapter 300C (see the dashed circles PSA1 to PSA4 in FIG. 7C), respectively. Thus, the four electrical contacts PSA1 to PSA4 and the four electrical contacts PSC1 to PSC4 are electrically connected to each other, respectively, while avoiding mechanical interference with the maintaining portion 106a of the shoe seat 106.

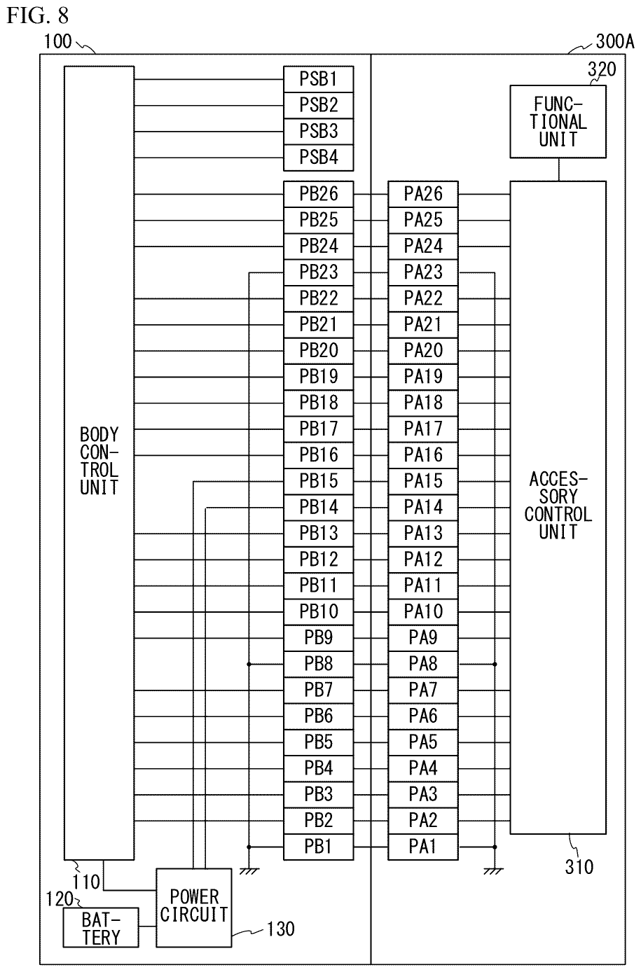

FIG. 8 is a block diagram schematically illustrating the configurations of the camera body 100 and an accessory (denoted as the accessory 300A) having the plug 301A similar to the EVF unit 300A. The camera body 100 includes a body control unit 110. The body control unit 110 includes a CPU (Central Processing Unit), a RAM (Random-Access Memory), a ROM (Read-Only Memory), and the like.

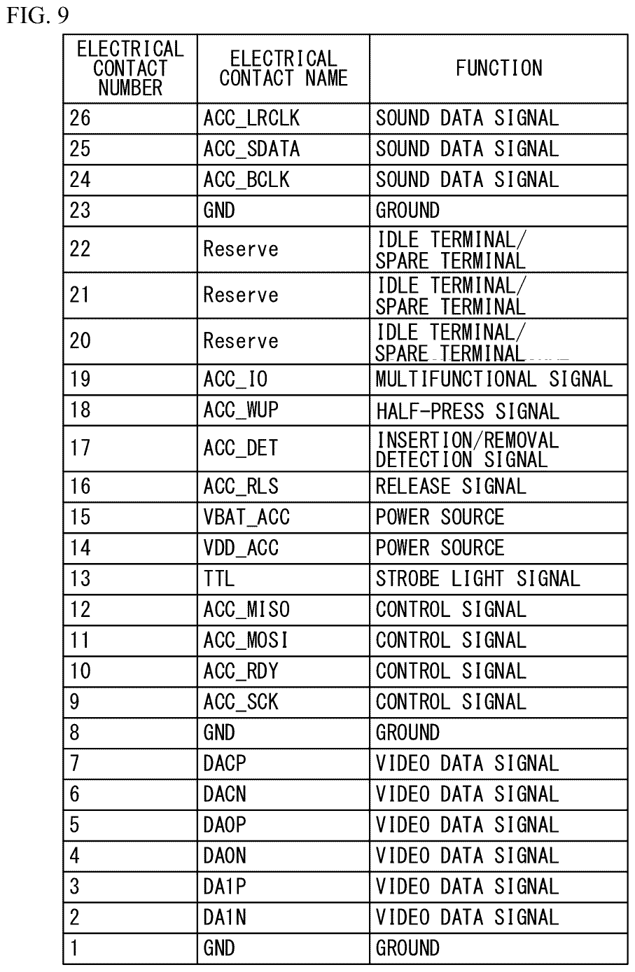

In the present embodiment, the functions as illustrated in FIG. 9 are assigned to the 26 electrical contacts PB1 to PB26 provided on the shoe seat 106. In particular, the electrical contacts PB2 to PB7 are contacts for transmitting video data signals to the accessory 300A. By sending the video data signals via the electrical contacts PB2 to PB7, the user can check an image being captured or an image that has been captured on a display screen of the accessory 300A such as the EVF. The electrical contacts PB9 to PB12 are contacts for transmitting control signals to the accessory 300A. The electrical contact PB13 is a contact for transmitting a strobe signal (a flash instruction signal to the flash device 300B). The electrical contacts PB14 and PB15 are contacts for supplying power to the accessory 300A. The voltage VDD and the voltage VBAT are supplied to the electrical contacts PB14 and PB15, respectively, from a power circuit 130 connected to a battery 120 based on the control from the body control unit 110.

The electrical contacts PB16 to PB19 are contacts used for exchanging a release signal, an insertion/removal detection signal, a half-press signal, and a multifunctional signal, respectively. The electrical contact PB19 is a terminal capable of receiving a plurality of types of signals from the accessories 300A and 300C. The type of signal output from the electrical contact PB19 varies depending on the type and manufacturer of the accessories 300A and 300C. By switching on and off of the pull-up by the body control unit 110 inside the camera body 100, the electrical contact PB19 can receive signals of various output types. The receivable signals include, for example, a signal of a CMOS output and a signal of an open drain output. When the accessory 300A or 300C is attached and the type thereof is determined, the body control unit 110 switches on and off the internal pull-up, and causes the electrical contact PB19 to receive a signal of the corresponding output form while the same accessory is attached. The electrical contacts PB24 to PB26 are contacts for transmitting sound data signals to the accessory 300A. The electrical contacts PB1, PB8, and PB23 are grounded, and the electrical contacts PB20 to PB22 are idle terminals (spare terminals). The idle terminals are provided to enable compatibility with new features of accessories and cameras through firmware updates, etc.

In the present embodiment, a group of the terminals PB2 to PB7 for the video data signals, a group of the terminals PB9 to PB12 for the control signals, a group of the terminals PB14 to PB15 for the power source, a group of the idle terminals PB20 to PB22, and a group of the terminals PB24 to PB36 for the sound data signals are arranged in this order from one side of the electrical contacts arranged in a row, the arrangement of the terminal groups may be changed. When the terminals are used for the same purpose, signals are often synchronized or the terminals are often connected to the same IC chip, and therefore, it is preferable to arrange the terminals for the same purpose continuously in order in terms of wiring. It is preferable to provide a GND (ground) terminal between the terminal groups. In the present embodiment, three terminals PB1, PB8, and PB23 are provided as GND (ground) terminals, but these terminals may be omitted as appropriate.

The accessory 300A includes an accessory control unit 310 and a functional unit 320. The functional unit 320 is a component for exhibiting the functions of the accessory 300A. When the accessory 300A is the EVF unit 300A, the functional unit 320 is a display device, and when the accessory 300A is a GPS receiver, the functional unit 320 is a GPS module. When the accessory 300A is attached to the camera body 100, as illustrated in FIG. 8, the 26 electrical contacts PA1 to PA26 of the accessory 300A are electrically connected to the 26 electrical contacts PB1 to PB26 provided on the shoe seat 106 of the camera body 100. On the other hand, nothing is connected to the four electrical contacts PSB1 to PSB4.

Although the accessory 300A of the present embodiment is provided with 26 electrical contacts as in the shoe seat 106 of the camera body 100, electrical contacts unnecessary for exhibiting the function of the accessory can be omitted as appropriate. For example, in the case of an EVF unit, the terminals for the sound data signals, the idle terminals, the terminal for the strobe signal, and the like may be omitted. In the case of an accessory having a microphone function, the terminals for the video data signal terminals, the idle terminals, the terminal for the strobe signal, and the like may be omitted. Further, depending on the type of the accessory, either one of the electrical contacts PB14 and PB15 relating to the power source may be omitted.

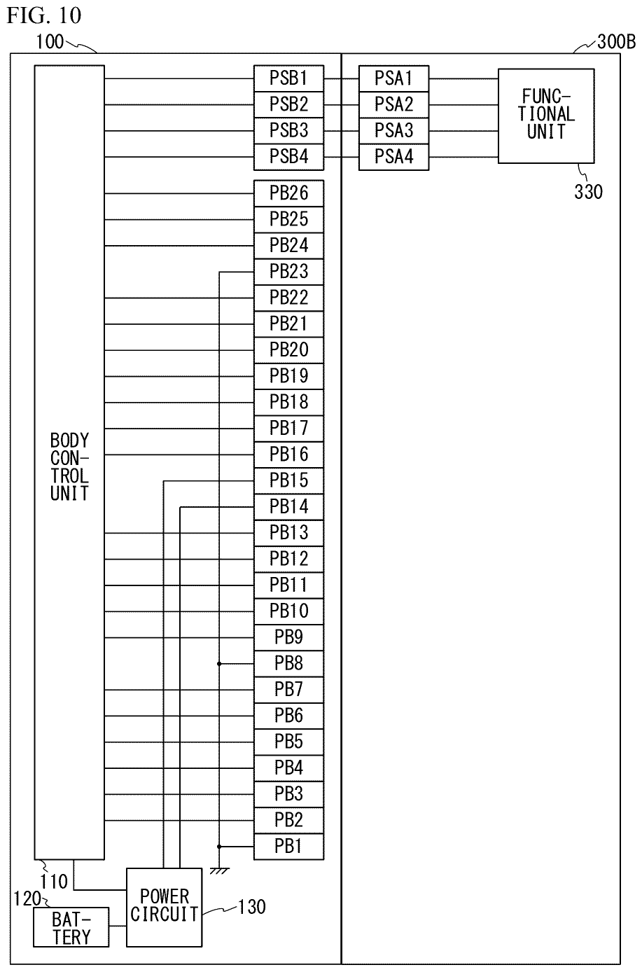

FIG. 10 is a block diagram schematically illustrating the configurations of the camera body 100 and an accessory (denoted as accessory 300B) having the plug 301B similar to that of the flash device 300B. In the example of FIG. 10, the accessory 300B includes four electrical contacts PSA1 to PSA4 and a functional unit 330. When the accessory 300B is a flash device, the functional unit 330 is a light emitting device.

When the accessory 300B in FIG. 10 is attached to the camera body 100, the four electrical contacts PSA1 to PSA4 of the accessory 300B are electrically connected to the four electrical contacts PSB1 to PSB4 provided on the shoe seat 106 of the camera body 100, respectively. On the other hand, nothing is connected to the 26 electrical contacts PB1 to PB26.

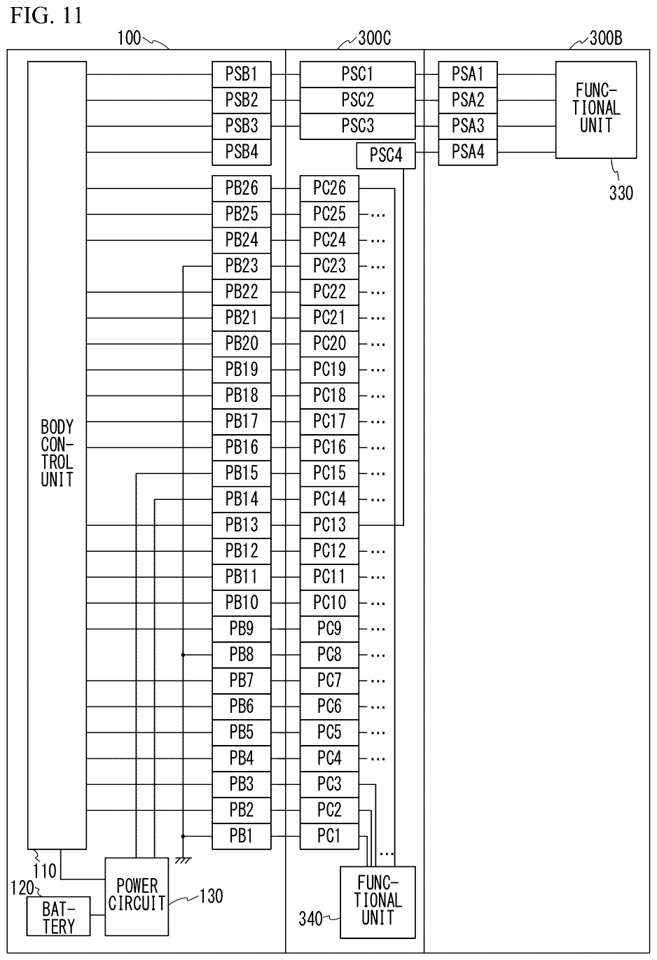

FIG. 11 is a block diagram schematically illustrating a configuration in which the intermediate adapter 300C is interposed between the camera body 100 and the accessory 300B. In the intermediate adapter 300C, the electrical contact PC13, which is one of the 26 electrical contacts PC1 to PC26, is electrically connected to the electrical contact PCS4 via a wiring line provided on the flexible printed circuit board, and the remaining 25 electrical contacts PC1 to PC12 and PC14 to PC26 are connected to a functional unit 340 via wiring lines provided on the flexible printed circuit board. The functional unit 340 is, for example, a transceiver device of a wireless remote controller.

When the accessory 300B is attached to the intermediate adapter 300C, the four electrical contacts PSA1 to PSA4 of the accessory 300B are electrically connected to the four electrical contacts PSC1 to PSC4 provided on the upper surface of the intermediate adapter 300C, respectively.

By using the intermediate adapter 300C, it is possible to simultaneously use the functions of the intermediate adapter 300C (for example, the functions as the transceiver device of the wireless remote controller) and the functions of the accessory 300B (for example, the functions of the flash device). This enables, for example, multi-flash (multi-light) photography in which the flash device and the accessory 300B (flash device) attached to the camera body 100 are caused to emit light by controlling the flash device located away from the camera body 100 using wireless communication.

### Arrangement of Electrical Contacts in Shoe Seat 106

Next, the arrangement of the electrical contacts in the shoe seat 106 of the camera body 100 will be described in detail. In the present embodiment, the number of electrical contacts arranged in a row is 26. Conventionally, when the electric contacts arranged in a row are provided on the shoe seat of the camera body 100, the number of the electric contacts is, for example, 21 or 15, and in the case of 21, the interval (pitch) between the electric contacts is approximately 0.45 mm. On the other hand, in the case where the number of the electrical contacts arranged in a row is 26 as in the present embodiment, the area where the electrical contacts can be arranged is specified by the standard, and therefore the interval (pitch) between the electrical contacts is narrower than that in the case where the number of the electrical contacts is 21, and is approximately 0.43 mm.

When the distance between electrical contacts becomes narrow as described above, foreign matters adhering to the electrical contacts may cause a short circuit between the electrical contacts. In particular, a short circuit occurring at the electrical contacts at both sides of the electrical contact PB15 (VBAT_ACC) illustrated in FIG. 9 becomes a problem.

In the present embodiment, the open drain contact or the electrical contact with the reverse current prevention function are arranged at both sides of the electric contact PB15 (VBAT_ACC). Here, the open drain contact means a contact connected to the drain terminal of the FET, and the contact with the reverse current prevention function means, for example, a contact to which a diode is connected or a contact connected to a power source via a circuit for preventing reverse current. In the present embodiment, the electrical contact PB16 (ACC_RLS) is arranged next to one side of the electrical contact PB15. The electrical contact PB16 (ACC_RLS) is an open drain contact. In the present embodiment, the electrical contact PB14 (VDD_ACC) is arranged next to the other side of the electrical contact PB15. The electrical contact PB14 (VDD_ACC) is a contact with a reverse current prevention function.

This prevents the electrical terminals at both sides of the electrical contact PB15 from being damaged by a short circuit. In the present embodiment, there are two terminals for supplying voltage, PB14 (VDD_ACC) and PB15 (VBAT_ACC), and electrical contacts for preventing damage are arranged at both sides of the electrical contact PB15 to which a higher voltage is supplied. The electrical contact PB14 is a contact for supplying a voltage that is lower than that of the electrical contact PB15 and controls the accessory 300. The electrical contact PB15 supplies power necessary for the accessory 300 to exhibit its function, and supplies high power and a variable voltage depending on the function. Therefore, in the present embodiment, the electrical terminals at both sides of the electrical contact PB15 are prevented from being short-circuited and being damaged to a large extent.

Examples of the electrical contacts that can be arranged at both sides of the electrical contact PB15 include ACC_WUP (half-press signal) (the electrical contact PB18 in FIG. 9) and the like, in addition to ACC_RLS and VDD_ACC. In the present embodiment, the electrical contact PB18 (WUP terminal) and the electrical contact PB16 (RLS terminal) are arranged at respective sides of the electrical contact PB17 (DET terminal) so that the electrical contact PB17 is sandwiched between the terminals that are pulled up. Both the electrical contact PB18 (WUP terminal) and the electrical contact PB16 (RLS terminal) are open drain contacts. Among the electrical contacts PB1 to PB26, the electrical contact PB17 (DET terminal), and the electrical contact PB15 (VBAT terminal) are terminals that especially need to be protected from damage or the like. In the present embodiment, the open drain contacts or the contacts with reverse current prevention functions are three electrical contacts PB14, PB16, and PB18, and the electrical contact PB17 (DET terminal) and the electrical contact PB15 (VBAT terminal) are arranged between two of the three terminals, respectively. With this arrangement, the electrical contacts can be efficiently arranged and protected from damage. The positions of the electrical contacts PB18 (WUP terminal) and the electrical contact PB16 (RLS terminal) may be interchanged.

Even when the number of electrical contacts arranged in a row is 22 to 25 or 27 or more, it can be said that the open drain contacts or the electrical contacts with the reverse current prevention function are to be arranged at both sides of the electrical contact VBAT ACC.

### Electrical Contact PB13

Next, the electrical contact PB13 will be described in detail. In the present embodiment, the electrical contact PB13 is a contact (TTL) for transmitting a strobe signal. The electrical contact PB13 is not used unless the flash device 300B is attached via the intermediate adapter 300C as illustrated in FIG. 11.

Therefore, in the present embodiment, the circuit is designed so that electrical contact PB13 functions when a signal (insertion/removal detection signal) indicating that the intermediate adapter 300C is attached to the camera body 100 is detected via the electrical contact PB17 (attachment detection contact). This prevents the electric contact PB13 from being short-circuited by a foreign object or the like that enters while the electric contact PB13 is not in use.

### Arrangement of Electrical Contacts for Video Data Signals

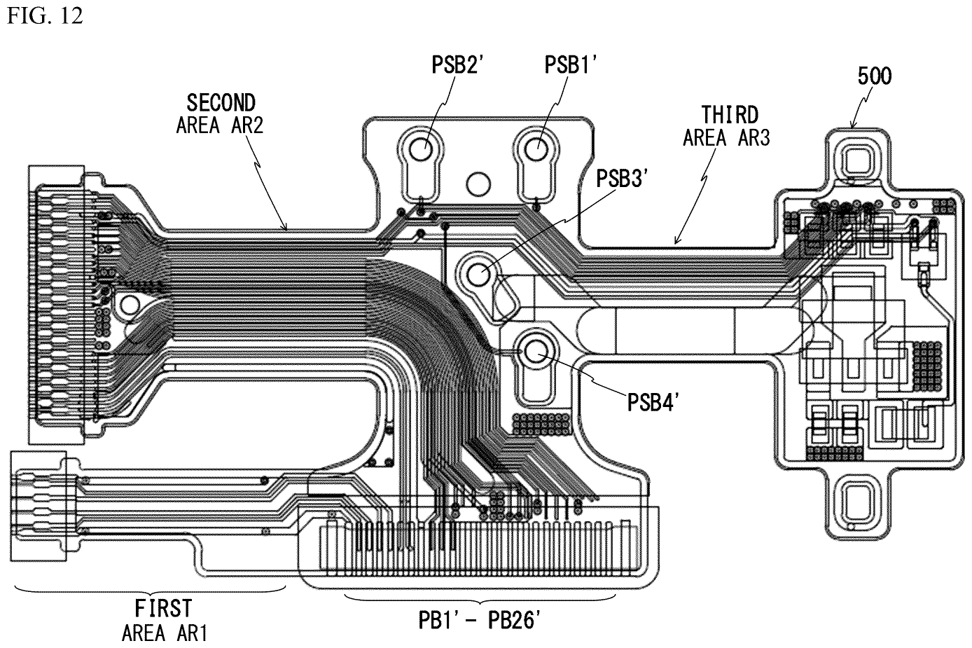

FIG. 12 illustrates an example of a flexible printed circuit (FPC) 500 on which wiring lines to be connected to electrical contacts provided on the shoe seat 106 of the camera body 100 are provided. The FPC 500 is an FPC used inside the camera body 100 (electronic viewfinder-less camera) that does not have an EVF. The FPC 500 is provided with terminals PB1′ to PB26′ to be connected to the above-described 26 electrical contacts PB1 to PB26, and terminals PSB1′ to PSB4′ to be connected to the four electrical contacts PSB1 to PSB4.

The FPC 500 in FIG. 12 includes a first area AR1 where wiring lines to be connected to the electrical contacts PB2 to PB7 for transmitting video data signals, a second area AR2 where other wiring lines are provided, and a third area AR3 where terminals PSB1′ to PSB4′ for the four electrical contacts PSB1 to PSB4 and wiring lines for driving the flash device are disposed. The terminals PB1′ to PB26′ and PSB1′ to PSB4′ are connected to the respective units in the camera body 100 through respective wiring lines provided in the FPC 500.

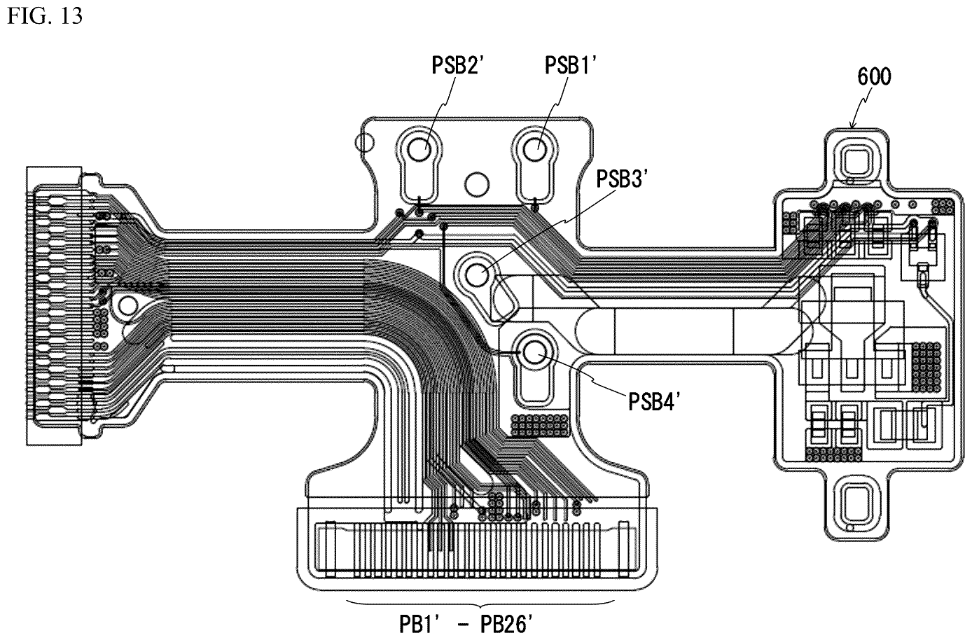

On the other hand, FIG. 13 illustrates an FPC 600 provided on the shoe seat 106 of the camera body 100 (camera with an electronic viewfinder) having an EVF provided from the outset. In the case of such a camera with an electronic viewfinder, it is not necessary to assume that an accessory (such as the EVF unit 300A) that needs to transmit video data signals is attached to the camera body 100. Therefore, in the example of FIG. 13, the wiring lines for the electrical contacts PB2 to PB7 for transmitting the video data signals are not required. In this case, unnecessary wiring lines are omitted, and the first area AR1 in FIG. 12 is omitted, so that the configuration in the camera body 100 can be simplified.

As described above, in the present embodiment, since the electrical contacts for transmitting the video data signals are collectively arranged on one end side of the row of the 26 electrical contacts in the shoe seat 106, an unnecessary area of the FPC can be reduced in the FPC 600 used for the camera with the electronic viewfinder.

This can reduce the cost.

As described in detail above, according to the present embodiment, the plug 301A (301C) provided to the accessory 300A (300C) attached to the camera body 100 has the connection portion 39A (39C) that is electrically connected to the shoe seat 106 of the camera body 100, and a plurality of the electrical contacts PA1 to PA26 (PCI to PC26) provided on the connection portion 39A (39C) and arranged in a row. Among the plurality of the electrical contacts PA1 to PA26 (PC1 to PC26), the electrical contact PA15 (PC15) (first contact) for receiving power from the camera body 100 is disposed next to the open drain contact or the contact with a reverse current prevention function. That is, the camera body 100 of the present embodiment has the shoe seat 106 electrically connected to the accessory 300, and the shoe seat 106 has the electrical contacts PB1 to PB26 disposed in a row. Among the electrical contacts PB1 to PB26, the electrical contacts (PB14 and PB16) adjacent to the power source contact (electrical contact PB15) used for supplying power from the camera body 100 to the accessory 300 is an open drain contact or a contact with a reverse current prevention function. This prevents the electrical contacts PB14 and PB16 from being short-circuited and damaged by a foreign object or the like.

In the present embodiment, the electrical contacts for preventing breakage are disposed at both sides of the electrical contact PB15 to which a higher voltage is supplied, among the terminals (PB14, PB15) for supplying the voltage. This prevents the electrical terminals at both sides of the electrical contact PB15 from being short-circuited and being damaged to a large extent. In the present embodiment, the electrical contact PB18 (open drain contact) and the electrical contact PB16 (open drain contact) are arranged at both sides of the electrical contact PB17 (DET terminal), so that the electrical contact PB17 is sandwiched by the terminals that are pulled up. This makes it possible to protect the electrical contacts from damage while efficiently arranging the electrical contacts.

According to the present embodiment, the shoe seat 106 includes the FPC (500 or 600) and the plurality of the electrical contacts PB1 to PB26 arranged in a row, and the plurality of the electrical contacts PB2 to PB7 for transmitting video data signals to the EVF unit 300A among the plurality of the electrical contacts PB1 to PB26 are collectively provided at one end of the row. This makes it possible to reduce an unnecessary area of the FPC in a case where the camera body 100 has an EVF. This can reduce the cost.

According to the present embodiment, the camera body 100 to which the accessory 300B such as a flash device is attached and to which the accessory 300B is attached via the intermediate adapter 300C includes the four electrical contacts PSB1 to PSB4 and the 26 electrical contacts PB1 to PB26. When the accessory 300B is attached, the electrical contact PSA1 to PSA4 of the accessory 300B are connected to the four electrical contacts PSB1 to PSB4. In contrast, when the accessory 300B is attached via the intermediate adapter 300C, the electrical contacts PSA1 to PSA4 of the accessory 300B are connected to the three electrical contacts PSB1 to PSB3 and the electrical contact PB13, which is one of the 26 electrical contacts PB1 to PB26. In this manner, by using the electrical contact PB13, which is one of the 26 electrical contacts PB1 to PB26, in place of the electrical contact PSB4, it is possible to attach the accessory 300B to the camera body 100 via the intermediate adapter 300C and use it even when the electrical contact PSB4 cannot be used when the intermediate adapter 300C is attached.

In addition, in the present embodiment, when it is detected that the intermediate adapter 300C is attached to the camera body 100 using the electrical contact PB17, which is one of the 26 electrical contacts, the electrical contact PB13 is made to function. This prevents foreign matters from entering while the intermediate adapter 300C is not attached, thereby preventing the electrical contact PB13 from shorting and breaking.

The shoe seat 106 described in the above embodiment may be provided in an electronic device other than cameras.

The above-described embodiments are preferred examples of the present invention. However, the present invention is not limited to this, and various modifications can be made without departing from the scope of the present invention.

1. A connection unit provided in an accessory to be attached to an imaging device, the connection unit comprising:
a connection portion electrically connected to the imaging device; and
a plurality of contacts provided in the connection portion and arranged in a row,
wherein among the plurality of contacts, a first contact to which power is supplied from the imaging device is arranged next to an open drain contact or a contact with a reverse current prevention function.

2. The connection unit according to claim 1, wherein an open drain contact or a contact with a reverse current prevention function is arranged at both sides of the first contact.

3. The connection unit according to claim 1, wherein a contact with a reverse current prevention function arranged next to the first contact is a second contact for receiving power supply from the imaging device at a voltage lower than that of the first contact.

4. The connection unit according to claim 1, wherein an open drain contact arranged next to the first contact is a third contact for transmitting a release signal from the imaging device.

5. The connection unit according to claim 4,
wherein a fourth contact for detecting attachment of the accessory is arranged next to the third contact, and
wherein the first contact, the third contact, and the fourth contact are arranged in this order.

6. The connection unit according to claim 5,
wherein a fifth contact for transmitting a half-press signal from the imaging device is arranged next to the fourth contact, and
wherein the first contact, the third contact, the fourth contact, and the fifth contact are arranged in this order.

7. An accessory comprising:
the connection unit according to claim 1; and
a functional unit that is electrically connected to the connection unit and has a function of the accessory.

8. An electronic device having a connection portion to which an accessory is attached and which is electrically connected to the accessory,
wherein the connection portion includes a plurality of contacts arranged in a row, and
wherein, among the plurality of contacts, a contact used for power supply from the electronic device to the accessory is arranged next to an open drain contact or a contact with a reverse current prevention function.

9. An electronic device having a connection portion to which an accessory is attached and which is electrically connected to the accessory,
wherein the connection portion includes a flexible printed circuit board and a plurality of contacts arranged in a row, and
wherein, among the plurality of contacts, a plurality of video signal contacts for transmitting video data signals to a display accessory attached to the electronic device are collectively provided at one end side of the row.

10. The electronic device according to claim 9,
wherein the electronic device is an imaging device that does not have an electronic viewfinder,
wherein the flexible printed circuit board has a first area and a second area, and
wherein a first group of wiring lines that connect each of the plurality of video signal contacts and the electronic device is provided in the first area, and a second group of wiring lines that connect contacts other than the plurality of video signal contacts of the plurality of contacts and the electronic device is provided in the second area.

11. The electronic device according to claim 9,
wherein the electronic device is an imaging device having an electronic viewfinder, and
wherein the flexible printed circuit board has no wiring line that connects each of the plurality of video signal contacts and the electronic device, and has wiring lines that connect contacts other than the plurality of video signal contacts of the plurality of contacts and the electronic device.

12. The electronic device according to claim 9, wherein the number of the contacts is 22 or more.

13-15. (canceled)
